(19) United States
(12) Patent Application Publication
(10) Pub. No.: US 2025/0093306 A1
(43) Pub. Date: Mar. 20, 2025

(54) SENSOR APPARATUS HAVING AT LEAST ONE SENSOR ELEMENT AND METHOD FOR PRODUCING A SENSOR APPARATUS

(71) Applicant: HELLA GmbH & Co. KGaA, Lippstadt (DE)

(72) Inventors: Thomas Niemann, Delmenhorst (DE); Karl Kreft, Achim (DE); Carsten Horst, Worpswede (DE); Hauke Baumgärtel, Ganderkesee (DE); Paul Deron, Hamburg (DE); Daniel Zöllner, Stuhr (DE); Falko Strackerjan, Bremen (DE); Daniel Peretzki, Bremen (DE)

(21) Appl. No.: 18/884,767

(22) Filed: Sep. 13, 2024

(30) Foreign Application Priority Data
Sep. 14, 2023 (DE) 10 2023 124 883.9

(51) Int. Cl. G01N 29/22; G01N 29/24

(52) U.S. Cl. CPC G01N 29/225; G01N 29/2437; G01N 2291/106

(57) ABSTRACT

A sensor apparatus has at least one sensor element, with at least one data conducting interface, with at least one power supply device and with at least one carrier structure, in which it is provided as essential to the invention that the carrier structure forms at least two segments and that the segments are connected flexibly to each other. For a method for producing a sensor apparatus, a carrier structure is provided, segments are produced from the carrier structure, and flexible connections are formed between the segments.

### BACKGROUND OF THE INVENTION

### Field of the Invention

The invention relates to a sensor apparatus having at least one sensor element, with at least one data conducting interface, with at least one power supply device and with at least one carrier structure.

### Description of Related Art

Sensor apparatuses of the type described may be implemented for example in in the automotive industry. For example, a sensor apparatus of such kind may be an apparatus for sensing moisture on a road surface. Such a sensor apparatus is known for example from DE 10 2017 102 745 A1. Here, it is provided that a sensor apparatus with a structure-borne sound sensor is arranged in a wheel arch of a motor vehicle in order to detect splash water thrown up by the tyres.

### SUMMARY

The problem to be addressed by the invention is that of suggesting a sensor apparatus of the kind described in the introduction, which offers a simple way to enable individual adaptability, particularly to curved substrates.

This problem is solved with a sensor apparatus having the features of claim 1. Further developments and advantageous variants are described in the subordinate claims.

In a sensor apparatus having at least one sensor element, with at least one data conducting interface, with at least one power supply device and with at least one carrier structure, it is provided as essential to the invention that the carrier structure forms at least two segments and that the segments are connected to one another flexibly.

A sensor apparatus of such kind may be intended for use in the automotive industry. A sensor element may have the form of a wide range of different sensor elements. For example, the sensor element may be a structure-borne sound sensor, a moisture sensor, a light sensor or similar. In particular, the sensor apparatus may also include multiple sensor elements, even of different kinds. In order to supply power to the sensor elements, the sensor apparatus may include for example a battery, a connection to an onboard power supply of the vehicle, an energy harvesting device or the like. The components of the sensor apparatus are arranged on a carrier structure, such as a circuit carrier, for example. In particular, the circuit carrier in such case may be of flexible design, in the form of a foil, for example. In order to ensure that the sensor apparatus can be adapted to the local conditions of the installation area, for example the wheel arch of the vehicle, the windscreen of the vehicle or other regions, the carrier structure forms at least two segments, preferably multiple segments. A segment may be a substantially flat area for accommodating various components of the sensor apparatus. The segments of the sensor apparatus may be substantially rectangular, for example, or also trapezoidal in shape, and may be arranged longitudinally one behind the other, so that the sensor apparatus has a substantially elongated form. Transition regions are formed between the segments and serve to connect the segments to each other flexibly. In the case of substantially rectangular, flat segments, the transition regions may be formed on the short sides of two adjacent segments. The flexible connection between two adjacent segments is preferably created by a flexible carrier material, in particular by the carrier structure of the sensor apparatus itself. Articulated connections arranged specifically for this purpose may also be provided. Through the flexible connection of two segments, said segments are connected to each other in a manner that is pliable enough to enable the surfaces of the segments to subtend an angle. In particular, the segments may each subtend a notional plane, and when the sensor apparatus is not in a curved state the planes of both segments may be arranged in one plane. The flexible connection allows the segments to be deflected out of this common plane. Bending or swivelling the segments of the sensor apparatus relative to each other enables the sensor apparatus to be adapted individually to the local conditions, in particular to curves. If the number of segments is increased, the bending radius can also be increased, which in turn enables the sensor apparatus to be adapted more flexibly to the curvature of the substrate. The connection points between two segments may be formed by the exposed carrier structure, although the connection points may also preferably be encased in a thin protective material. The protective material may be a thermosetting plastic, for example. The protective casing is preferably of thinner construction at the connecting areas than in the areas of the segments that are occupied by components. For example, the sensor apparatus may be embodied as an apparatus for detecting moisture on a road surface and consequently may easily be conformed to the inside of a wheel arch liner by bending the various segments relative to each other in such a way that the sensor apparatus is adapted to the radius or the curvature of the wheel arch liner.

In a further development of the invention, the carrier structure is designed flexibly, and the flexible connection between the segments is formed by sections of the carrier structure. The carrier structure may be a flexible circuit carrier. This may be designed as a foil or similar. For example, the carrier structure may be an elongated strip of a flexible circuit carrier, from which the various for example rectangular segments are formed. The carrier structure and the individual segments may also be round. In particular, the segments may be arranged around centrally placed segment. Due to the flexible design of the carrier structure, at the same time a flexible connecting region is also created between the segments.

In one embodiment of the sensor apparatus, the carrier structure is elongated, and the segments and the flexible connections between the segments are formed from the elongated carrier structure. The carrier structure may be an elongated strip of a flexible circuit carrier. The various rectangular segments may be formed from the strip, and then be arranged one behind the other. The flexible connections between adjacent segments may be formed by narrower areas of the strip-like carrier structure, thus enabling a high degree of flexibility here.

In one embodiment of the invention, at least one segment has a trapezoidal footprint. The segment surfaces may have, for example, a rectangular, trapezoidal or similar footprint. With a trapezoidal design of the segment surfaces, it is possible for the bending points—that is to say the connecting areas between the segments—not to be aligned parallel to each other, thus enabling an individual adaptation to the local conditions at the site of use of the sensor apparatus.

In one embodiment of the invention, at least one segment surrounds at least a section of at least one other segment. The segments may be structured by the carrier structure in such a way that at least one segment surrounds at least a section of a central segment. For example, the carrier structure and the segments may be circular in shape, and the segments may be arranged concentrically about a central segment. A rectangular shape may also be provided of a central segment, which is surrounded by the other segments. Areas of the carrier structure are formed between the segments, by which the segments are connected flexibly to each other. The connecting areas between the segments may in particular be formed free spaces on the carrier structure, which are not occupied by components.

In one embodiment of the invention, at least one segment has a rounding. The segments may have for example a circular, oval or similar shape. The segments may be arranged entirely around a central, middle segment, in the form of circular rings, for example. It may also be provided that at least sections of segments are arranged around a non-central, laterally offset segment.

In one embodiment of the invention, the segments are substantially circular in form, and the segments are arranged substantially concentrically. For example, a central segment may be circular in shape. Further segments may be arranged in a ring around this segment at least in a section thereof. For example, a structure-borne sound sensor may be arranged on a central segment. Evaluators, power supply or the like may be arranged on the other segments. Unoccupied, for example annular areas of the carrier structure may be arranged between the segments, by which flexible connecting areas are formed between the segments, which are also annular in shape. The flexible connection of the segments enables a vibration decoupling of the segments to take place, so that the central segment is not influenced by the other segments.

In one embodiment of the invention, the flexible connection between two adjacent segments is formed by strut-like sections of the carrier structure. Free spaces may be arranged between the struts, which can connect the segments with each other. The free spaces may be formed by openings in the carrier structure. The connection by means of the structure and the free spaces arranged between them enables a particularly high degree of flexibility to be achieved between the segments.

In a further development of the invention, at least two adjacent segments are each surrounded by a protective body, and the minimal angle between the two segments is delimited by the outer shape of the respective protective bodies. At least one segment, preferably all segments of a sensor apparatus, may each be surrounded by a protective body. The protective body may be a kind of housing, for example. The protective body is preferably a casing with a protective medium, an epoxy resin, for example. The epoxy resin and protective housing may be of such a shape that a bending of two adjacent segments relative to each other is limited by the shape, which is to say that the minimal angle between the two segments is predefined. Thus, two adjacent segments may be bent relative to each other until the protective bodies touch each other. In particular, for this purpose the protective bodies may be more substantial or thicker in the middle of the segments along the lengthwise extension of the carrier structure than in the transition regions to the adjacent segment. From one segment end to the next segment end in the direction of the longitudinal extension, the thickness of the protective body may first increase relative to the carrier structure, then have a constant region, and then decrease again. The protective bodies may be arranged on both sides of the carrier structure, which is to say both above and below it. In such a case, various slopes in a side view of the protective bodies may be provided on both sides of the carrier structure. Two segments can be bent relative to each other by the rising or falling shape of the protective bodies of the two segments, so that for example the entire sensor apparatus describes a radius, wherein the minimal angle between two segments is delimited spatially by the design of the protective bodies. The connection areas between the segments may be surrounded by a different protective medium than the segments themselves.

In one embodiment of the invention, the protective bodies have lateral areas facing the connection areas between two segments, and the lateral areas each subtend an angle with the carrier structure. In particular, the protective bodies of the segments may have a middle region that is arranged substantially parallel to the carrier structure. The protective body may be thickest in this region. Lateral areas may be arranged on both sides of this middle region, and decline in the direction of the carrier structure. The notional planes subtended by the lateral areas subtend an angle with the carrier structure. The minimal angle between two adjacent segments is defined by the angle between the lateral areas and the carrier structure.

In one embodiment of the invention a first segment is equipped with sensor elements, and a second segment includes a power supply. The arrangement of the different components of the sensor apparatus on different segments makes it possible to create a modular construction of a sensor apparatus. For example, a fixed segment or a power supply, with a battery or similar for example, may be provided, and may be combined with different segments having different sensor elements. This enables inexpensive production and inexpensive adaptation of a sensor apparatus to meet different requirements.

In one embodiment of the invention, a further segment includes the data conducting interface and/or at least one further segment includes an evaluator. A data conducting interface may be for example a plug for connection to a cable-connected data line of the vehicle, a wireless transmitter such as a Bluetooth transmitter, or similar. The arrangement of the respective components on different segments makes it possible to carry out a modular adaptation of the sensor apparatus to the respective requirements. For example, prefabricated segments with data conducting interfaces, evaluators and power supplies may be used in combination with various sensor elements. An evaluator may be for example a microcontroller or similar computing devices.

In one embodiment of the invention, the minimal angle between two adjacent segments is limited by the distance between the segment. For example, the protective bodies may also be substantially cuboid in shape. In order to enable a flexible connection between two adjacent segments, the protective bodies of the adjacent segments may be far enough apart from each other to ensure that a mobility of both segments is not impeded by the protective bodies. A greater distance between the protective bodies also allows a longer flexible section of the carrier structure between the segments, thereby ensuring greater movement capability of the segments relative to each other. If the distance is large enough, two segments may be moved practically freely with respect to each other.

In one embodiment of the invention, at least one segment has a mounting region for mounting the sensor apparatus. Preferably, all segments have a mounting region, via which the individual segments and therewith the entire sensor apparatus can be mounted at the desired location. For example, the sensor apparatus may be mounted on the insider of a wheel arch liner by the mounting regions of the segments. A mounting region may be for example a volume provided for this purpose; that is to say a reservoir, on a side of a protective housing, in which adhesive may be kept. In this way, the individual segments may be bonded adhesively to the component that is to be monitored. In addition, protrusions or depressions may be provided in the protective bodies and may mate with corresponding clips and/or engaging devices that are provided for example on the mounting site to form a detent or clip connection.

In a further development of the invention, at least one segment includes a rigidly constructed area to accommodate components that are to be soldered. In order to enable the accommodation and soldering of components that are to be soldered, areas of at least one segment may be of rigid construction, in the form of a perforated plate or similar, for example.

In one embodiment of the invention, a sensor element is constructed as a piezoelectric element. The sensor apparatus may be for example a sensor apparatus for detecting structure-borne sound signals. These may be used for detecting moisture that is thrown up from the road surface, for example. The piezoelectric element for detecting the structure-borne sound signals may be arranged on a segment of the sensor apparatus and placed in contact such as to conduct structure-borne sound signals, which is to say vibration-transmitting contact with the component that is to be monitored, via an adhesive connection.

In a further development of the invention, the segment that includes the piezoelectric element has a lower mass than the other segments. In order to realise the most direct, uninterrupted and undistorted vibration transmission possible from the object to be monitored to segment equipped with the structure-borne sound sensor, the mass of the segment is as low as possible. This measure is also intended to prevent the wave originating at the component to be monitored from being influenced significantly by the sensor apparatus.

In a further development of the invention, an acoustic impedance jump is formed between at least two adjacent segments. In order to improve the sensitivity of the sensor apparatus, in particular to improve the sensitivity of the segment having a structure-borne sound sensor, i.e. a piezoelectric element, an acoustic impedance jump is created between the sensing segment to the adjacent segments. This may be done for example by changing the cross section of the segments, which is to say for example by changing the size of the protective body or by changing the size of the segments. Reflections of the propagating waves may form at the places where the cross section is changed, with the result that a vibration is not transmitted from one segment to the next, for example. An impedance jump can also be created at the transition from a segment to the connection region. For example, the flexible connection may be formed by a narrower region of the carrier structure, thus creating a change in the cross section. The higher an acoustic impedance jump is, the more effectively the transfer of structure-borne sound is damped. Accordingly, a change of the adjacent segment has less influence on the sensor element, which is to say the signal chain.

A further aspect of the invention relates to a method for producing a sensor apparatus, in particular a sensor apparatus according to the invention, wherein a carrier structure is produced, wherein it is provided as essential to the invention that segments are produced from the carrier structure and that flexible connections are formed between the segments. The carrier structure is preferably a flexible, for example foil-like circuit carrier, to which conducting paths or other items are or can applied. The carrier structure is trimmed in such a way that individual, contiguous segments are created. These segments are connected to each other flexibly, wherein the flexible connection is formed in particular by the flexible carrier structure. The segments may be furnished with protective bodies, wherein the protective body may consist of a protective medium. Now sensor elements, power supply elements, data line elements for example or similar may be arranged in a cavity of a protective body. An injection moulding process may be implemented for the production. In this case, a tool with interchangeable inserts may be used for the different variants of a sensor. This enables the tool to be adapted easily to each of the sensor apparatuses that are to be produced. A modular configuration of the sensor apparatus is made possible by the segmented construction of the sensor apparatus. The individual segments of the sensor apparatus can also be produced by applying protective bodies to a carrier structure.

In a further development of the method, the flexible connection of the segments is formed by the carrier structure. Because the carrier structure is formed on a flexible material, the segments can be produced integrally from the carrier material, as it were, so that they are connected by sections of the carrier material. In this way, a flexible connection of the segments is provided by the flexible carrier material.

### BRIEF DESCRIPTION OF THE DRAWINGS

In the following text, the invention will be explained further with reference to an embodiment illustrated in the drawing. In detail, the schematic illustrations show in:

FIG. 1: a sensor apparatus with two segments;

FIG. 2: a sensor apparatus with three segments;

FIG. 3: a sensor apparatus with four segments;

FIG. 4: a sensor apparatus with a communication segment;

FIG. 5: a sensor apparatus according to the invention in a wheel arch liner;

FIG. 6: a segment with an adhesive reservoir;

FIG. 7: a sensor apparatus with a protectively surrounded connection point between the segments;

FIG. 8: a sensor apparatus with a segment having a rigid area;

FIG. 9: a sensor apparatus with trapezoidal segments;

FIG. 10: a sensor apparatus with protective bodies;

FIG. 11: a sensor apparatus with segment in the uncurved state;

FIG. 12: a sensor apparatus according to FIG. 11 in the curved state, and

FIG. 13: a sensor apparatus with concentrically arranged round segments;

FIG. 14: a sensor apparatus with round segments;

FIG. 15: a sensor apparatus with round segments according to FIG. 13 in a perspective view, and

FIG. 16: a sensor apparatus according to FIG. 13 mounted on a wheel arch liner.

### DETAILED DESCRIPTION OF THE INVENTION

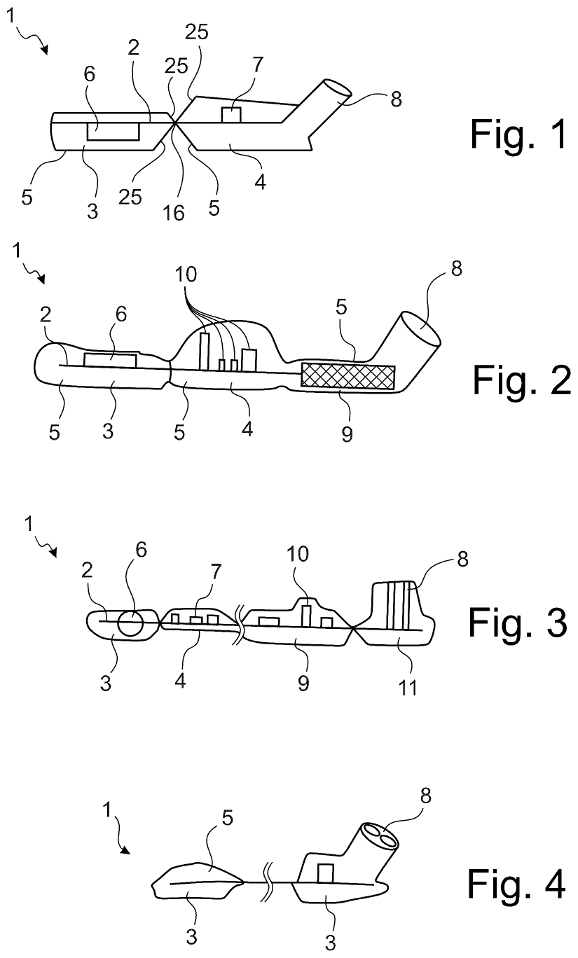

FIG. 1 represents a sensor apparatus 1 having a carrier structure 2, and segments 3, 4. The carrier structure 2 is formed by a flexible circuit carrier, in particular a circuit carrier in the form of a foil. Segments 3 and 4 each have a protective body 5, which may be formed by a protective medium, for example. Segment 3 has sensing elements, which is to say sensor elements 6. Segment 4 is equipped with an evaluator 7. Segment 4 also has an interface 8 in the form of a plug. Interface 8 may be used for example for connecting in data conducting manner or also for the power supply. In this context, depending on requirements the plug may be produced at various angles to the carrier structure 2, for example at a 45° angle, a 60° angle or a 90° angle depending on the requirement. Segments 3 and 4 are connected flexibly to one another by a connection point 16, which is formed by the flexible carrier structure 2. The protective bodies 5 have slants 25 at the connection point 16, by which the minimal angle between segments 3 and 4 when bending is limited.

FIG. 2 represents a sensor apparatus 1 with segments 3, 4 and 9. In this embodiment, segment 3 has the sensor elements 6 and an evaluator (not shown). In this embodiment, segment 4 is equipped with components 10 for voltage protection and transforming, while segment 9 has a plug 8. In this context, segments 4 and 9 may be standard segments, which are usable in many sensor apparatuses, while segment 3 with the sensor elements 6 is adapted to the respective use case.

FIG. 3 represents a sensor apparatus 1 with four segments 3, 4, 9, 11. In this embodiment, a segment 3 has sensor elements 6, segment 4 has an evaluator 7, segment 9 has a voltage protector or voltage transformation 10, and segment 11 includes interface 8.

FIG. 4 represents a sensor apparatus 1 with a multiplicity of segments 3. As the number of segments increases, so too can the bending radius be increased, and the sensor apparatus 1 can accordingly be adapted more flexibly to the curvature of the substrate. As well as the number of segments, the distance between the segments may also be increased.

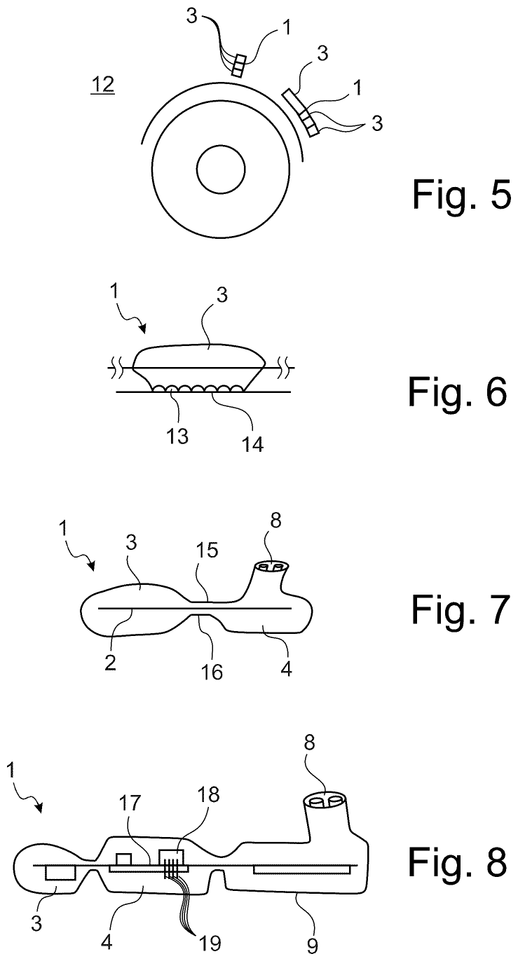

FIG. 5 represents a sensor apparatus 1 in the wheel arch liner 12 of a motor vehicle. The flexible arrangement of the segments 3 makes it possible to adapt the sensor apparatus 1 to the rounding of the wheel arch liner 12.

FIG. 6 represents a segment 3 with a reservoir 13 for adhesives. An adhesive may be contained in the reservoir 13, with which the sensor apparatus 1 can be mounted on a body 14 that is to be monitored.

FIG. 7 represents a sensor apparatus 1 having segments 3 and 4, in which a connection area 16 is surrounded by a protective medium 15. In this context, the connection point 16 may be formed by a section of the flexible carrier structure 2.

FIG. 8 represents a sensor apparatus 1 with segments 3, 4 and 9. Segment 4 includes a rigid section 17, which is formed by a rigid circuit carrier. This enables electronic components 18 with wire connections 19 to be soldered.

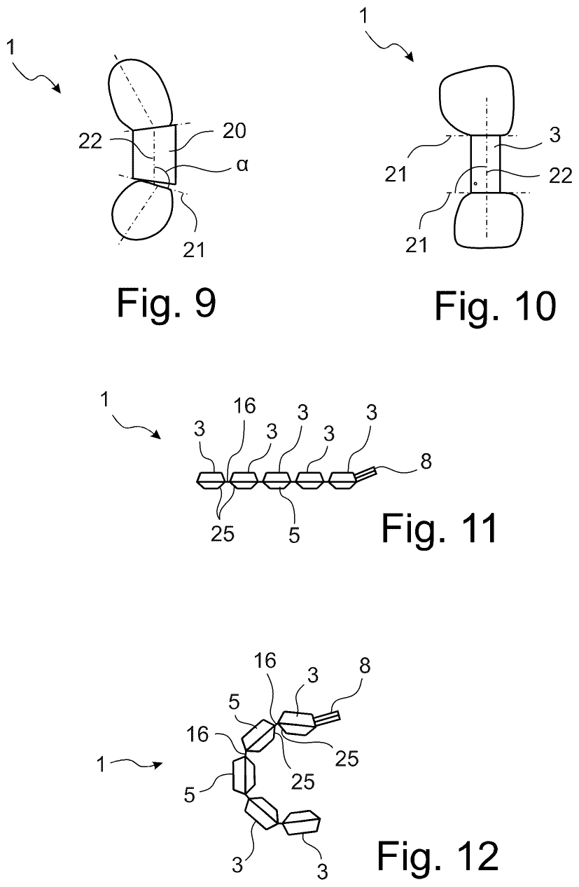

FIG. 9 represents a sensor apparatus 1 with trapezoidal segment 20. A trapezoidal segment 20 enables the sensor apparatus 1 to be shaped. In particular, a fold axis 21 may subtend an angle α to the longitudinal axis 22 of the carrier structure 2.

In FIG. 10, the segment 3 is rectangular and the folding axis 21 forms a 90° angle with the longitudinal axis 22.

FIG. 11 shows a side view of a sensor apparatus 1 with segments 3. The segments 3 each have a protective body 5. The lateral areas of the protective bodies 5 are designed in such manner that the define the minimum fold angle between two adjacent segments. The connection areas 16 are formed by flexible sections of the carrier structure 2.

FIG. 12 represents a sensor apparatus 1 according to FIG. 11 in the bent state.

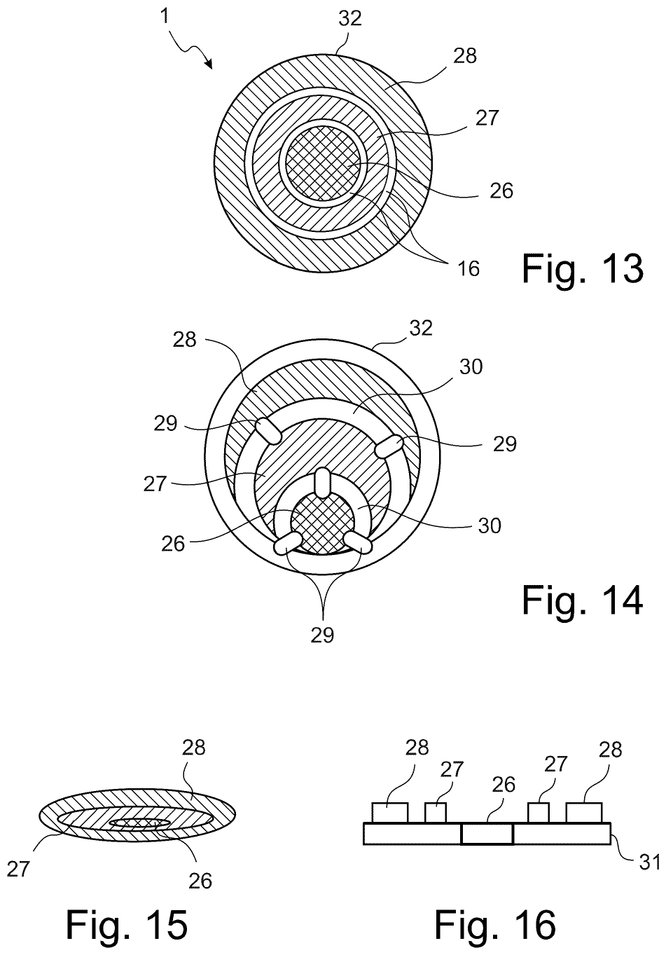

FIG. 13 represents a sensor apparatus 1 with a round carrier structure 32 having round segments 26, 27, 28. The segments 27 and 28 surround the segment 26 which is located centrally in the middle and are arranged concentrically therewith. Segments 26, 27, 28 are connected to each other flexibly via flexible connections 16. The connection areas 16 are formed by sections of the carrier structure 2.

FIG. 14 represents a sensor apparatus 1 with round segments 26, 27, 28. The segments 27 and 28 surround portions of segment 26. The segments 26, 27, 28 are connected to each other via flexible connections, wherein the connections are formed by strut-like sections 29 of the carrier structure 32 and free spaces 30 arranged between them.

FIG. 15 represents a perspective view of a sensor apparatus 1 having round segments 26, 27, 28 according to FIG. 13.

FIG. 16 represents a sensor apparatus 1 mounted in a wheel arch liner 31 of a motor vehicle, in cross section. Here, the sensor apparatus 1 may be designed to detect liquid thrown up by the tyres by means of structure-borne sound. The central segment 26 in this case includes the structure-borne sound sensor system. The segment 26 is vibration damped by means of the flexible connection with the other segments.

1. A sensor apparatus having at least one sensor element, with at least one data conducting interface, with at least one power supply device, and with at least one carrier structure,
wherein
the carrier structure forms at least two segments, and
that the segments are connected flexibly to each other.

2. The sensor apparatus according to claim 1, wherein the carrier structure is designed flexibly, and that the flexible connection between the segments is formed by sections of the carrier structure.

3. The sensor apparatus according to claim 1, wherein the carrier structure is of elongated design, and that the segments and the flexible connections between the segments are formed from the elongated carrier structure.

4. The sensor apparatus according to claim 3, wherein at least one segment has a trapezoidal footprint.

5. The sensor apparatus according to claim 1, wherein at least one segment surrounds at least a section of at least one further segment.

6. The sensor apparatus according to claim 5, wherein at least one segment has a rounding.

7. The sensor apparatus according to claim 5, wherein the segments are substantially circular in shape, and that the segments are arranged substantially concentrically.

8. The sensor apparatus according to claim 1, wherein the flexible connection between two adjacent segments is formed by strut-like sections of the carrier structure.

9. The sensor apparatus according to claim 1, wherein at least two adjacent segments are each surrounded by a protective body, and that the minimal angle between the two segments is delimited by the outer shape of the respective protective bodies.

10. The sensor apparatus according to claim 9, wherein the protective bodies have lateral areas facing the connection areas between two segments, and that the lateral areas each subtend an angle with the carrier structure.

11. The sensor apparatus according to claim 1, wherein a first segment has sensor elements, and that a second segment has a power supply.

12. The sensor apparatus according to claim 11, wherein at least one further segment has the data conducting interface, and/or that at least one further segment has an evaluator.

13. The sensor apparatus according to claim 1, wherein the minimal angle between two adjacent segments is limited by the distance of the segments from each other.

14. The sensor apparatus according to claim 1, wherein at least one segment has a mounting region for mounting the sensor apparatus.

15. The sensor apparatus according to claim 1, wherein at least one segment has at least one rigidly constructed area to accommodate components that are to be soldered.

16. The sensor apparatus according to claim 1, wherein at least one sensor element has the form of a piezoelectric element.

17. The sensor apparatus according to claim 16, wherein the segment with the piezoelectric element has a lower mass than the other segments.

18. The sensor apparatus according to one of claim 16 or 17, wherein an acoustic impedance jump is formed between at least two segments.

19. A motor vehicle with the sensor apparatus according to claim 1.

20. A method for producing the sensor apparatus; according to claim 1, wherein a carrier structure is provided,
wherein segments are produced from the carrier structure, and
that flexible connections are formed between the segments.

21. The method for producing the sensor according to claim 20, wherein the flexible connection of the segments is formed by the carrier structure.
